(19) United States
(12) Patent Application Publication
(10) Pub. No.: US 2007/0121170 A1
(43) Pub. Date: May 31, 2007

(54) Method of encoding a latent image

(76) Inventors: Lawrence David McCarthy, Victoria (AU); Gerhard Frederick Swiegers, Victoria (AU)

Correspondence Address: LADAS & PARRY, 5670 WILSHIRE BOULEVARD, SUITE 2100, LOS ANGELES, CA, 90036-5679, US

(21) Appl. No.: 10/559,254

(22) PCT Filed: Jun. 4, 2004
(86) PCT No.: PCT/AU04/00746

§ 371 Date: Sep. 14, 2006

(30) Foreign Application Priority Data
Jun. 4, 2003 (AU) 2003902810

(51) Int. Cl. G06K 15/00

(52) U.S. Cl. 358/3.28

(57) ABSTRACT

There is disclosed a method of forming a latent image. The method involves transforming a subject image into a latent image having a plurality of latent image element pairs. The latent image elements of each pair are spatially related to one another and corresponding to one or more image elements in said subject image. The transformation is performed by allocating to a first latent image element of each pair, a value of a visual characteristic representative of the one or more corresponding image elements of the subject image, and allocating to a second latent image element of the pair a value of a visual characteristic which is substantially complementary to the value of the visual characteristic allocated to the first latent image.

### FIELD OF THE INVENTION

The present invention relates to a method of forming a latent image from a subject image. Embodiments of the invention have application in the provision of security devices which can be used to verify the legitimacy of a document, storage media, device or instrument, for example a polymer banknote, and novelty, advertising or marketing items.

### BACKGROUND TO THE INVENTION

In order to prevent unauthorised duplication or alteration of documents such as banknotes, security devices are often incorporated within as a deterrent to copyists. The security devices are either designed to deter copying or to make copying apparent once copying occurs. Despite the wide variety of techniques which are available, there is always a need for further techniques which can be applied to provide a security device.

### SUMMARY OF THE INVENTION

The invention provides a method of forming a latent image, the method comprising:
transforming a subject image into a latent image having a plurality of latent image element pairs, the latent image elements of each pair being spatially related to one another and corresponding to one or more image elements in said subject image, said transformation being performed by
allocating to a first latent image element of each pair, a value of a visual characteristic representative of the one or more corresponding image elements of the subject image, and
allocating to a second latent image element of the pair a value of a visual characteristic which is substantially complementary to the value of the visual characteristic allocated to said first latent image.

Thus, each first latent image element within the primary pattern has a nearby complementary latent image element which conceals the latent image, rendering it an encoded and concealed version of the subject image.

Depending on the embodiment, the pair of latent image elements may correspond to one, two or more subject image elements.

The value of the visual characteristic allocated to the first latent image element may be a combination of the values of the visual characteristics of the corresponding subject image elements or a cluster of image elements about a pair of subject image elements, such as an average or some other combination.

In one embodiment, the method typically involves:
a) forming a subject image by dithering an original image into subject image elements which have one of a set of primary visual characteristics; and
b) selecting spatially related pairs of subject image elements in the subject image to be transformed.

The invention also provides an article having thereon a latent image that encodes and conceals a subject image, the latent image comprising:
a plurality of latent image element pairs, the image elements of each pair being spatially related to one another, each image element pair corresponding to one or more image elements of a subject image,
a first latent image element of each pair having a first value of a visual characteristic representative of the value of a visual characteristic of the one or more corresponding image elements of the subject image, and
a second latent image element of each pair having a second value of a visual characteristic substantially complementary to said first value.

The invention also provides a method of verifying the authenticity of an article, comprising providing a primary pattern on said article, said primary pattern containing a latent image comprising:
a plurality of latent image element pairs, the image elements.of each pair being spatially related to one another, each image element pair corresponding to one or more image elements of a subject image,
a first latent image element of each pair having a first value of a visual characteristic representative of the value of a visual characteristic of the one or more corresponding image elements of the subject image, and
a second latent image element of each pair having a second value of a visual characteristic substantially complementary to said first value; and
providing a secondary pattern which enables the subject image to be perceived.

The article may be a security device, a novelty item, a document, or an instrument.

### BRIEF DESCRIPTION OF THE DRAWINGS

Preferred embodiments of the invention will be described with reference to the accompanying drawings in which:

FIG. 1 is an original, undithered image of the example of the second preferred embodiment;

FIG. 2 is FIG. 1 after processing with an “ordered” dithering procedure;

FIG. 3 depicts only the “on” pixels in each pixel pair of the image in FIG. 2 after the grey-scale of these pixels have been averaged over both pixels in the original, dithered pixel pairs;

FIG. 4 depicts only the “off” pixels of each pixel pair of the image in FIG. 2 after they have been transformed into the complementary grey-scale of their corresponding “on” pixels depicted in FIG. 3;

FIG. 5 depicts the resulting primary pattern;

FIG. 6 depicts the secondary pattern which corresponds to the primary pattern shown in FIG. 5; and

FIG. 7 is the image perceived by an observer when the primary pattern is overlaid with the secondary pattern, that is, when the concealed image in FIG. 5 is decoded and revealed using the decoding pattern shown in FIG. 6.

FIG. 8a is a subject image or an original image and FIG. 8b is a primary pattern of FIG. 8a obtained by transforming FIG. 8a as described in the second embodiment of this specification using a chequered arrangement of pixel pairs;

FIG. 9 is FIG. 8a after a scrambling algorithm is applied;

FIG. 10a is FIG. 9 after applying the identical transformation as that employed to transform FIG. 8a to FIG. 8b. The bottom right-hand portion of FIG. 10b depicts FIG. 10a after the corresponding secondary screen pattern is overlaid upon it, that is when the concealed image in FIG. 10a is decoded and revealed by its decoding screen;

FIGS. 11a and 11b show a pair of subject images;

FIGS. 12a and 12b show a pair of secondary patterns;

FIGS. 13a and 13b show a pair of primary patterns derived from the subject images and screens of FIGS. 11 and 12;

FIG. 14 shows the latent images of FIGS. 13a and 13b combined in a single primary pattern; and

FIG. 15 shows how FIG. 14 may be decoded and revealed by the corresponding secondary patterns.

### DESCRIPTION OF THE PREFERRED EMBODIMENTS

In each of the preferred embodiments the methods of the preferred embodiment are used to produce a primary pattern which encodes a latent image formed from a subject image. A complementary secondary pattern is provided which allows the latent image to be decoded. A recognisable version of the subject image can be viewed by overlaying the primary pattern with the secondary pattern.

The latent image is formed by transforming the subject image. The latent image is made up of latent image element pairs. The image elements are typically pixels. That is, the smallest available picture element of the method of reproduction. Each latent image element pair corresponds to one or more subject image elements in the subject image in the sense that they carry visual information about the image elements to which they correspond. More specifically, a first latent image element carries information about the image element or elements to which it corresponds and a second latent image element has the complementary value of the visual characteristic to thereby act to obscure the information carried by the first latent image element of the pair when the latent image or primary pattern is observed from a distance without a secondary pattern (or mask) overlaying it.

Each latent image element pair in the primary pattern will correspond to either one, two or more image elements in the subject image. Where the latent image element corresponds to a single subject image element it will be appreciated that the latent image will contain twice as many image elements as the subject image. In these embodiments, the value of the first visual characteristic image element may be the value of the visual characteristic in the corresponding image element in the subject image. However, it will be appreciated that it need only take a value which is representative of the information which is carried by the image element in the subject image. For example, if the subject image element is a white pixel in an area which is otherwise full of black pixels, sufficient information will be preserved in the latent image if the subject image element is represented as a black pixel in the latent image. Accordingly, the image element may take the value of the image element or a value derived from a cluster of pixels surrounding the corresponding image element (i.e. the mean, median or mode) and still take a value which is representative of the image element.

In those embodiments where there are the same number of image elements in the latent image and in the subject image, the value of the visual characteristic of the first image element in each pixel pair in the latent image will typically be calculated by the average of the values of the visual characteristic of the corresponding subject image elements. The latent image element may also take a value based on the image elements which surround the pair of image elements or on some other combination of the values of the visual characteristics of the corresponding pair of subject image elements.

Where the pair of latent image elements corresponds to more than two pixels, there will be fewer image elements in the primary pattern than in the subject image. For example, four image elements in the subject image may be reduced to two image elements in the latent image. Again, in some embodiments, a value of the visual characteristics may be derived from surrounding image elements and still be representative of the corresponding subject image elements.

Typically, the subject image will be formed from an original image by conducting a dithering process to reduce the number of different possible visual characteristics which can be taken by the image element in the subject image and hence also the number of visual characteristics which can be taken by the first latent image element and therefore also the second latent image element of the corresponding pair in the latent image of the primary pattern.

The term “primary visual characteristic” is used to refer to the set of possible visual characteristics which an image element can take, either following the dithering process or after the transformation to a latent image. The primary visual characteristics will depend on the nature of the original image, the desired latent image, and in the case of colour images, on the colour separation technique which is used.

In the case of grey-scale images, the primary visual characteristics are a set of grey-scale values and may be black or white.

In the case of colour images, colour separation techniques such as RGB or CYMK may typically be used. For RGB the primary visual characteristics are red, green and blue, each in maximum saturation. For CYMK, the primary visual characteristics are cyan, yellow, magenta and black, each in maximum saturation.

The value that the visual characteristic takes after transformation of the subject image to a latent image will typically relate to the density of the image elements in the subject image. That is, where the subject image is a grey-scale image, the corresponding visual characteristic in the latent image may be a grey-scale value and where the subject image is a colour image, the corresponding visual characteristic in the latent image may be a saturation value of the hue of the image element.

A complementary visual characteristic is a density of grey or hue which, when combined with the visual characteristic of the first latent image element, delivers a substantially intermediate tone. In the case of grey-scale elements, the intermediate tone is grey. For colour image elements, the complementary hues are as follows:

| Hue | Complementary hue |
|---|---|
| cyan | red |
| magenta | green |
| yellow | blue |
| black | white |
| red | cyan |
| green | magenta |
| blue | yellow |

Again, where there is an averaging process or other combination process which occurs in order to combine information from a plurality of pixels in the original image into the a single latent image element in the latent image, the corresponding latent image element may take the nearest value of the set of primary visual characteristics.

The dithering process which is used will depend on the spatial relationship between the image elements in the latent image and the latent image quality. It is preferred that the dithering technique which is used reduces the amount of error and hence noise introduced into the latent image. This is particularly important in embodiments where the number of image-carrying pixels is reduced relative to the subject image; for example, those embodiments where four image elements in the original image correspond to a pair of image elements in the final image, only one of which carries information. Accordingly, preferred dithers of embodiments of the present invention are error diffusion dithers. Typical dithers of this type include Floyd-Steinberg (PS), Burke, Stucki dithers which diffuse the error in all available directions with various weighting factors. In these techniques the error is dissipated close to the source. Another approach is to dither along a path defined by other space filling curves that minimise traversement in any single direction for a great distance. The most successful of these is due to Riemersma, (http://www.compuphase.com/riemer.htm) who utilised the Hilbert curve (David Hilbert in 1892). (Other space filling curves exist but they are rare.)

Riemersma's method is particularly suited to embodiments of the present invention as it vastly reduces directional drift by constantly changing direction via the Hilbert curve and gradually “dumps” the error in such a way as to minimise noise (image elements which do not carry pertinent information) in the resulting latent image. An advantage to embodiments of the invention is that an evenly distributed portion of the diffused error is lost when every second pixel is lost during a transformation from the subject to latent image, hence maximising the quality of the latent image.

Typically, the primary pattern will be rectangular and hence its latent image elements will be arranged in a rectangular array. However, the image elements may be arranged in other shapes.

The image elements in each image element pair will typically be spatially related by being adjacent to one another. However, the image element pairs will be spatially related provided they are sufficiently close enough to one another so as to provide the appearance of a uniform intermediate shade or hue when viewed from a distance. That is, so that each first image element is close enough to a second image element that between them they provide a uniform intermediate hue or shade.

Image element pairs will typically be selected in a regular fashion, such as alternating down one column or one row, since this allows the secondary pattern to be most easily registered with the primary pattern in overlay. However random or scrambled arrangements of image element pairs may be used.

A secondary pattern will typically have transparent and opaque pixels arranged in such a way that when overlaid upon the primary pattern, or in certain cases when it is itself overlaid by the primary pattern, it masks all of the first or all of the second of the paired image elements in the primary pattern, thereby revealing the image described by the other image elements.

The shape of the secondary pattern will depend on the manner in which the image element pairs are selected. The secondary pattern will typically be a regular array of transparent and opaque pixels. For example, a secondary pattern may be a rectangular array consisting of a plurality of pure opaque vertical lines, each line being 1 pixel wide and separated by pure transparent lines of the same size. Another typical secondary pattern may be a checkerboard of transparent and opaque pixels. However random and scrambled arrays, may also be used, provided the opaque pixels in the secondary pattern are capable of contrasting all or nearly all of the first or second image elements of the paired image elements in the primary pattern. It will also be appreciated that the secondary pattern can be chosen first and a matching spatial relationship for the image element pairs chosen afterwards.

### Manual Embodiment

A first embodiment of the invention is now described which demonstrates the principle of the invention in its simplest form and how it can be implemented manually. The first embodiment is used to form a primary pattern which is a grey-scale image which encodes a latent image.

1. In the first embodiment, a photograph, its identically sized negative, and a black sheet are overlaid upon each other in exact registration, with the black sheet at the top. The overlaid sheets are then cut from the top of the underlying photograph/negative to their bottoms into slivers (image elements) of equal width and length, without disturbing the vertical registration of the black sheet, the photograph, and its negative. Every second sliver in all of the photograph (the original image), the negative, and the overlaid black sheet are then carefully discarded without disturbing the position of the other slivers. The black sheets remaining at the top of the pile then describe a repeating pattern of cut-out (transparent) slivers with intervening black (opaque) slivers. This pattern is the secondary pattern or decoding screen.

2. The photograph (which is both the original and subject image) and its negative are then reconstituted into a single composite image in which the missing slivers in the photograph are replaced with the identically sized negative slivers that are underneath the positive slivers immediately to the left of the missing slivers. That is, these are image elements in the negative which correspond to the image elements remaining in the positive, which, by their nature, have a complementary value of a visual characteristic to the positive. The resulting picture is the primary pattern. Thus, the primary pattern has pairs of spatially related image elements, one of which takes the original value of a corresponding image element in the subject image and the other of which takes the complementary value to the original value.

3. When the secondary pattern is overlaid upon the primary pattern in exact registration, only the slivers belonging to one of the original photograph or its negative can be seen at a time; the other slivers are masked. The image perceived by the observer is therefore a partial re-creationof the original image or its negative.

Because the primary pattern contains equal amounts of complementary light and dark, or coloured, image elements in close proximity to each other, it appears as an incoherent jumble of image elements having intermediate visual characteristic. This is especially true if the slivers have been cut in extremely fine widths. Thus, the primary pattern encodes and conceals the latent image and its negative. The primary pattern is decoded by use of the secondary pattern.

### Grey-scale Embodiments

In grey-scale embodiments of the invention, the method is used to encode grey-scale images. In these embodiments, the set of values of the visual characteristic which is used is a set of different shades of grey.

In a second preferred embodiment the image elements are pixels. Herein, the term “pixel” is used to refer to the smallest picture element that can be produced by the selected reproduction process—e.g. display screen, printer etc.

In this embodiment the primary pattern is created from an original subject image. In grey-scale embodiments, the original image is typically a picture consisting of an array of pixels of differing shades of grey. However, the original image may be a colour image which is subjected to an additional image processing step to form a grey-scale subject image.

In the first preferred embodiment, the primary pattern is chosen to be a rectangular array (or matrix) of pixels. After a suitable array is chosen, the primary pattern is mathematically prepared from an original image as follows:

1. In cases where the original image is not already dithered and where the media required to reproduce the primary pattern and its corresponding secondary pattern, such as a printer or a display device, is capable only of producing image elements which are either black or white, or a few selected shades of grey, each pixel in the original image is dithered into pixels having only one of the available shades: for example, white (Sₒ) or black (S_{y}), which are primary visual characteristics in some grey-scale embodiments (y=an integral number). The dithered image is referred to herein as the subject image. The value of y−1 in this formulation equals the total number of shades available, and created during the dithering process (excluding white).

2. Each pixel is now assigned a unique address (p, q) according to its position in the [p×q] matrix of pixels. (If the original image or the primary pattern is not a rectangular array then the position of pixels can be defined relative to an arbitrary origin, preferably one which gives positive values for both co-ordinates p and

3. Each pixel in the subject image is designated as being either black, white, or an intermediate tone, and assigned the descriptor (p,q)Sₙ, where n=0 (white) or y (black) or an integral value between 0 and y corresponding to its shade of grey (where y−1 equals the number of intermediate shades of grey present in the image with n=1 corresponding to the least intense shade of grey and n=y−1 corresponding to the most intense shade of grey.

4. Pixels are now sorted into spatially related pairs. This sorting may be achieved in any manner desired. For example, pairs may be selected sequentially down rows or across columns or in any other manner, provided the pairs are adjacent to each other or nearly adjacent to each other. A small number of pixels may be left out in this process because they do not have an adjacent or nearby pixel which is not already paired. Such pixels are typically treated as if they were one of the nearest pixel pair.

5. A first pixel in each pair in the subject image is assigned to be an “on” pixel and a second pixel is assigned to be the corresponding “off” pixel. “On” pixels are designated as (p,q)Sₙ^{on}. “Off” pixels are designated as (p,q)Sₙ^{off}. Typically the “on” and “off” pixels are selected in an ordered and regular manner so that a secondary pattern can be easily formed. For example, if the adjacent pairs are selected sequentially down rows, the top pixel of each pair may be always designated the “on pixel” and the bottom pixel, the “off” pixel. A wide variety of other ordered arrangements can, of course, also be employed.

6. The pixel matrix is now traversed while a transformation algorithm is applied. The direction of traversement is ideally sequentially up and then down the columns, or sequentially left and right along the rows, from one end of the matrix to the other. However, any traversement, including a scrambled or random traversement may be used. Ideally, however, adjacent pixel pairs are transformed sequentially. All of the pixel pairs in the matrix are transformed. 7. A variety of transformation algorithms may be employed. In a typical algorithm, the value of Sₙ in the pixel (p,q)Sₙ^{on} in every pixel pair is changed to Sₘ and the pixel is re-designated to be (p,q)Sₘ^{on}, where
m=(nₒₙ+n_{off})/2
and nₒₙ=the value on n in Sₙ^{on} of the pixel pair, while n_{off}=the value of n in Sₙ^{off} of the pixel pair. In cases where m is calculated as a non-integral number, it may be rounded up, or rounded down to the next nearest integral number. Alternatively, it may be rounded up in one case and rounded down in the next case, as the algorithm proceeds to traverse the pixel matrix. Other variations, including random assignment of the higher or lower value, may also be employed. Alternatively, the algorithm may only be able to assign one of a fixed set of values—e.g. black, white, or intermediate grey using a Boolean algorithm. It will be appreciated that following this step the “on” pixel in the transformed subject image (i.e. the latent image element) takes a value of the visual characteristic which is representative of the values of the pair of pixels with which it corresponds or the values of pixels clustered about the pair of pixels to which it corresponds.

Whatever of the above algorithms are applied, the value of Sₙ in the corresponding pixel (p,q)Sₙ^{off} is now also transformed to SX and the pixel is re-designated to be (p,q)Sₓ^{off}, where
x=y−m (where y equals the total number of grey-shades present, including black; see step 3 above)

Thus, if the on-pixel in any pair is made white, the off-pixel becomes black. If the on-pixel is made black, the off-pixel becomes white. It will accordingly be appreciated that each off-pixel will have a value of the visual characteristic which is complementary to the value of the on-pixel with which it is paired. Thus, the on-pixel has become the first latent image element of a pair and the off-pixel the second latent image element of the pair.

Application of such an algorithm over the entire pixel matrix generates the primary pattern which encodes a latent image and conceals the original image.

8. A secondary pattern is now generated by creating a p×q matrix of pixels having the same dimensions as the primary pattern. All of the pixels having the same (p,q) coordinates as “off” pixels in the primary pattern are made opaque. All of the pixels in this matrix having the same (p,q) coordinates as the “on” pixels in the primary pattern are made transparent. The resulting image is the secondary pattern.

When secondary pattern is overlaid upon the primary pattern, or is itself overlaid by the primary pattern in perfect register, all of either the “on” pixels, or all of the “off” pixels are masked, allowing the other pixel set to be seen selectively. A partial re-creation of the subject image or of its negative is thereby revealed. Thus, the image is decoded. Alternatively, a lens array which selectively images all of the “on” pixels or all of the “off” pixels may be used to decode the image.

In a variant of the second preferred embodiment, the density of the pixels in the primary pattern (after step 7) or in the original or subject image (after step 1) may be additionally subjected to an algorithm which partially scrambles them in order to better disguise the encoding. An example of this variant is provided in Example 2.

The dithering and the concealment procedures may also be combined into a single process wherein the visual characteristic of the complementary, “off” pixels are calculated in conjunction with the dithered pixels and, if necessary, also in conjunction with nearby pixels. The method of dithering may have to be modified in this respect. For example, the dither may need to operate from one pixel to the next pixel in a traverse of all the pixels present with or without relying on the surrounding hidden pixels for correct depiction of the required shades. Such specialised dithering algorithms may be modifications of dither algorithms known to the art or new algorithms developed for the purpose. Dither algorithms can be applied as a software application or as part of the firmware of a printer or other device used for the production of images.

The primary pattern of the second preferred embodiment will typically be a rectangular array of pixels. However, the primary pattern may have a desired shape—e.g. the primary pattern may be star-shaped.

The techniques and algorithms shown above provide the broadest possible contrast range and hence provide the latent image with the highest possible resolution for a greyscale picture involving the number of shades of grey employed. The use of complementary pixel pairs, one of which is directly related to the original image, allows the maximum amount of information from the original or subject image to be incorporated within the primary image whilst still retaining its concealment.

### Colour Embodiments

The methods of the colour embodiments are suitable for producing colour effects in encoded colour images. In the colour embodiments, hue (with an associated saturation) is the visual characteristic which is used as the basis for encoding the image. As with the grey-scale embodiments the image elements are pixels, printer dots, or the smallest image elements possible for the method of reproduction employed.

In the third embodiment, primary hues are colours that can be separated from a colour original image by various means known to those familiar with the art. A primary hue in combination with other primary hues at particular saturations (intensities) provides the perception of a greater range of colours as may be required for the depiction of the subject image. Examples of schemes which may be used to provide the primary hues are red, green and blue in the RGB colour scheme and cyan, yellow, magenta, and black in the CYMK colour scheme. Both colour schemes may also be used simultaneously. Other colour spaces or separations of image hue into any number of primaries with corresponding complementary hues may be used.

In these embodiments, saturation is the level of intensity of a particular primary hue within individual pixels of the original image. Colourless is the lowest saturation available; the highest corresponds to the maximum intensity at which the primary hue can be reproduced. Saturation can be expressed as a fraction (i.e. colourless=0 and maximum hue=1) or a percentage (i.e. colourless=0% and maximum hue =100%) or by any other standard values used by practitioners of the art (e.g. as a value between 0 and 256 in the 256-colour scheme).

In the third preferred embodiment, the primary pattern is again chosen to be a rectangular array (or matrix) of pixels. After a suitable array is chosen, the primary pattern is mathematically prepared from an original image as follows:

1. The number of primary hues (N_{H}) to be used in the primary pattern is decided upon (depending also upon the media to be used to produce the primary pattern) and their complementary and mixed hues identified. In the case of the RGB and CYMK primary colour schemes, the complementary hues are set out in Table 1:

TABLE 1

| Colour | | Complementary |
|---|---|---|
| Separation | Hue | hue |
| CYMK | cyan | red |
| | magenta | green |
| | yellow | blue |
| | black | white |
| | white | black |
| RGB | red | cyan |
| | green | magenta |
| | blue | yellow |

As is convention, white refers to colourless pixels.

The mixed hues are set out in Table 2:

TABLE 2

| Colour | | |
|---|---|---|
| Separation | Hues | Mixed hue |
| CYMK | cyan + magenta | blue |
| | magenta + yellow | red |
| | cyan + yellow | green |
| | any colour + black | black |
| | any colour + white | that colour |
| | any colour + itself | that colour |
| RGB | red + blue | magenta |
| | blue + green | cyan |
| | red + green | yellow |
| | any colour + itself | that colour |

Other colour spaces or separations of hue with corresponding complementary hues, known to the art, may be used.

2. In cases where the original image is not already dithered and where the media required to reproduce the primary pattern, such as a printer or a display device, is capable only of producing image elements which are certain primary colours having particular saturations, each pixel in the original image is dithered using dithering techniques into pixels having only one of the available primary colours in its available saturation, such as one of the RGB shades or one of the CYMK shades. Thus, there is formed a dithered image referred to herein as the subject image.

3. Each pixel is now assigned a unique address (p,q) according to its position in the [p×q] matrix of pixels. (If the original image or the primary pattern is not a rectangular array, then the position of pixels can be defined relative to an arbitrary origin, preferably one which gives positive values for both co-ordinates p and q).

4. Each pixel is further designated as being either black or white or one of the selected hues and assigned the descriptor (p,q)Sₙ, where n=1 (hue 1) or 2 (hue 2) . . . NH (hue NH), or NH+1 (black), or −(NH+1) (white). In this formula, the values −n correspond to the associated complementary hues as described in step 1.

5. The saturation, x, of the hue of each pixel is now defined and the pixel is designated (p,q)Sₙ^{X}, where the number of saturation levels available is w, and x is an integral number between 0 (minimum saturation level) and w (maximum saturation level) 6. Pixels are now sorted into spatially related pairs. This sorting may be achieved in any manner desired. For example, pairs may be selected sequentially down rows or across columns or in any other manner, provided the pairs are adjacent to each other or nearby each other. A small number of pixels may be left out in this process because they do not have an adjacent or nearby pixel which is not already paired. Such pixels are typically treated as if they were one of the nearest pixel pair.

7. A first pixel in each pair is assigned to be an “on” pixel and a second pixel is assigned to be the corresponding “off” pixel. “On” pixels are designated as (p,q)Sₙ^{x-on} “Off” pixels are designated as (p,q)Sₙ^{x-off}.

8. The pixel matrix is now traversed while a transformation algorithm is applied. The direction of traversement is ideally sequentially up and down the columns, or sequentially left and right along the rows, from one end of the matrix to the other. However, any traversement, including a scrambled or random traversement may be used. Ideally, however, adjacent pixel pairs are transformed sequentially. All of the pixel pairs in the matrix are transformed.

9. A variety of transformation algorithms may be employed. In a typical algorithm, the value of Sₙ^{x} in the pixel (p, g)Sₙ^{x-on} in every pixel pair is changed to Sₘ^{j} and the pixel is re-designated to be (p,q)Sₘ^{j-on}, where
Sₘ^{j} corresponds to the mixed hue, m, with the mixed saturation, j, obtained by mixing Sₙ^{x-on} with Sₘ^{x-off}

For example, if Sₙ^{x-on} is red in a saturation 125 (in a 256 colour saturation system) and Sₙ^{x-off} is blue in a saturation 175, then Sₘ^{j-on} becomes magenta in a saturation 150.

Whatever algorithm is applied above, the value of Sₙ in the corresponding pixel (p,q)Sₙ^{x-off} is now also transformed to S.ₘ^{j-off} and the pixel is re-designated to be (p,q)S.ₘ^{j-off}, where
S.ₘ corresponds to the complementary hue of Sₘ in the associated “on” pixel in the pixel pair.

Thus, for example, if the on-pixel in a particular pair is made red, the off-pixel becomes cyan. If the on-pixel is made magenta, the off-pixel becomes green. The saturation levels of the hues in the transformed “on” and “off” pixels are identical.

An alternative algorithm suitable for use in the colour preferred embodiment involves changing the value of Sₙ, in the pixel (p,q)Sₙ^{x-on} in every pixel pair to S_{y} and the pixel being re-designated to be (p,q)S_{y}^{x-on}, where
S_{y} equals Sₙ in either the pixel (p,q)Sₙ^{x-on} or the pixel (p,q)Sₙ^{x-off} within the pixel pair, chosen randomly or alternatively, or by some other method.

The value of Sₙ in the corresponding pixel (p,q)Sₙ^{x-off} in the pixel pair is now also changed to S_{-y} and the pixel is re-designated to be (p,q)S_{-y}^{x-off}, where
S_{-y} corresponds to the complementary hue of S_{y} in (p,q)S_{y}^{x-on}.

Application of such algorithms over the entire pixel matrix generates the primary pattern in which a latent image is encoded from the subject image.

10. A secondary pattern is now generated by creating a p×q matrix of pixels having the same dimensions as the primary pattern. All of the pixels having the same (p,q) coordinates as “off” pixels in the primary pattern are made opaque. All of the pixels in this matrix having the same (p,q) coordinates as the “on” pixels in the primary pattern are made transparent. The resulting image is the secondary pattern.

When such a secondary pattern is overlaid upon the primary pattern, or is itself overlaid by the primary pattern in perfect register, all of either the “on” pixels, or all of the “off” pixels are observed. Thus, the image is decoded.

In a variation of the second preferred embodiment, the density of the pixels in the primary pattern (after step 9) or in the subject image (after step 2) may be additionally subjected to an algorithm which partially scrambles them in order to better disguise the encoding.

As with the second embodiment, the dithering and the concealment procedures may also be combined in a single process wherein the visual characteristic of the complementary, “off” pixels are determined in conjunction with the dithered pixels and, if necessary, also in conjunction with nearby pixels. The method of dithering may have to be modified in this respect. For example, the dither may need to operate from one pixel to the next pixel in a traverse of all the pixels present with or without relying on the surrounding hidden pixels for correct depiction of the required shades. Such specialised dithering algorithms may be modifications of dither algorithms known to the art or new algorithms developed for the purpose. Dither algorithms can be applied as a software application or as part of the firmware of a printer or other device used for the production of images.

The techniques and algorithms shown above provide the broadest possible contrast range and hence provide the latent image with the highest possible resolution for a colour picture involving the primary hues employed. The use of complementary pixel pairs, one of which is directly related to the original image, allows the maximum amount of information from the original image to be incorporated in the primary image whilst still retaining its concealment.

### Alternative Embodiments

Persons skilled in the art will appreciate that a number of variations may be made to the foregoing embodiments of the invention, for example, while the image elements are typically pixels, the image elements may be larger than pixels in some embodiments—e.g. each image element might consist of 4 pixels in a 2×2 array.

In some embodiments, once the primary pattern has been formed, a portion (or portions) of the primary pattern may be exchanged with a corresponding portion (or portions) of the secondary pattern to make the encoded image more difficult to discern.

Other colour spaces or separations of hue with corresponding complementary hues, known to the art, may be used in alternative embodiments.

Further security enhancements may include using colour inks which are only available to the producers of genuine bank notes or other security documents, the use of fluorescent inks or embedding the images within patterned grids or shapes.

The method of at least the second preferred embodiment may be used to encode two or more images, each having different primary and secondary patterns. This is achieved by forming two primary images using the method described above. The images are then combined at an angle which may be 90 degrees (which provides the greatest contrast) or some smaller angle. The images are combined by overlaying them at the desired angle and then keeping either the darkest of the overlapping pixels or the lightest of the overlapping pixels or by further processing the combined image (e.g. by taking its negative), depending on the desired level of contrast. Two or more images may, additionally, be encoded to employ the same secondary pattern.

In the first and third embodiments, the secondary pattern has been applied in the form of a mask or screen. Masks and screens are convenient as they can be manufactured at low cost and individualised to particular applications without significant expense. However, persons skilled in the art will appreciate that lenticular lense arrays could also be used as the decoding screens for the present invention. Lenticular lense arrays operate by allowing an image to only be viewed at particular angles.

Persons skilled in the art will appreciate that inks can be chosen to enhance the effect of revealing the latent image. For example, using fluorescent inks as the latent image elements will cause the image to appear bright once revealed under a stimulating light source.

Persons skilled in the art will also appreciate that a large number of different screens can be used, provided the quality of maintaining a spatial relationship is achieved. For example, the invention may employ screens of the type disclosed in FIG. 19 of U.S. Pat. No. 6,104,812.

### Application of the Preferred Embodiments

The method of preferred embodiments of the present invention can be used to produce security devices to thereby increase security in anti-counterfeiting capabilities of items such as tickets, passports, licences, currency, and postal media. Other useful applications may include credit cards, photo identification cards, tickets, negotiable instruments, bank cheques, traveller's cheques, labels for clothing, drugs, alcohol, video tapes or the like, birth certificates, vehicle registration cards, land deed titles and visas.

Typically, the security device will be provided by embedding the primary pattern within one of the foregoing documents or instruments and separately providing a decoding screen in a form which includes the secondary pattern. However, the primary pattern could be carried by one end of a banknote while the secondary pattern is carried by the other end to allow for verification that the note is not counterfeit.

Alternatively, the preferred embodiments may be employed for the production of novelty items, such as toys, or encoding devices.

### EXAMPLE 1

In this example, a primary pattern is formed using the method of the second preferred embodiment.

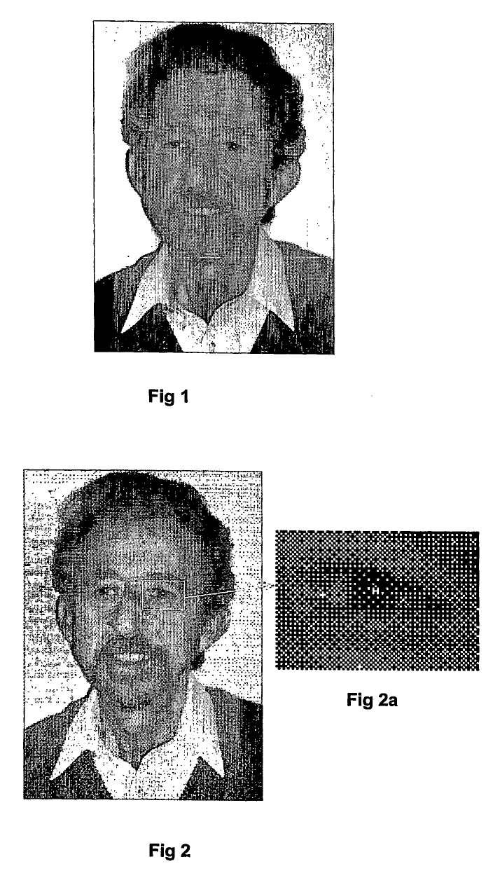

The continuous tone, original image shown in FIG. 1 is selected for encoding. This image is converted to the dithered image, depicted in FIG. 2, using a standard “ordered” dithering technique known to those familiar with the art.

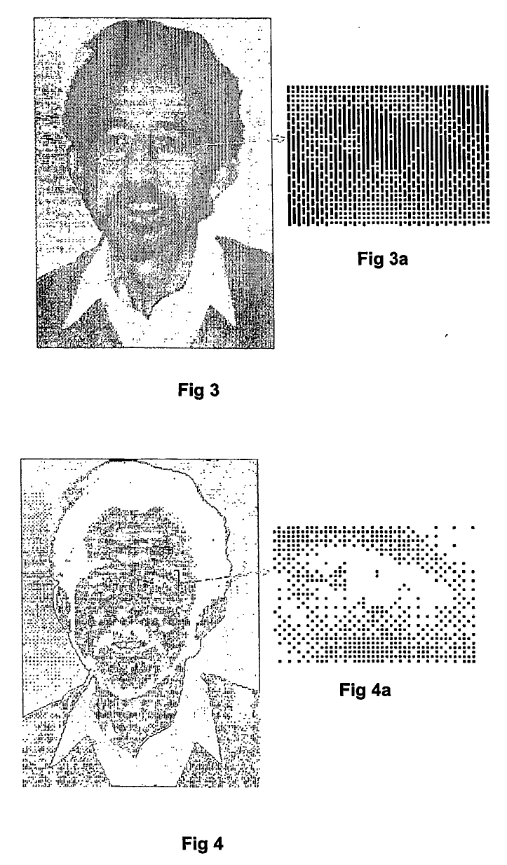

FIG. 3 depicts only the “on” pixels in each pixel pair of the image in FIG. 2 after the grey-scale of these pixels have been averaged over both pixels in the pixel pair. As can be seen, pixel pairs have been selected such that the “on” pixels lie immediately to the left of their corresponding “off” pixels, with the pixel pairs arrayed sequentially down every two rows of pixels.

In FIG. 4, only the “off” pixels of each pixel pair of the image in FIG. 2 are depicted, after they have been transformed into the complementary grey-scale of their corresponding “on” pixels depicted in FIG. 3.

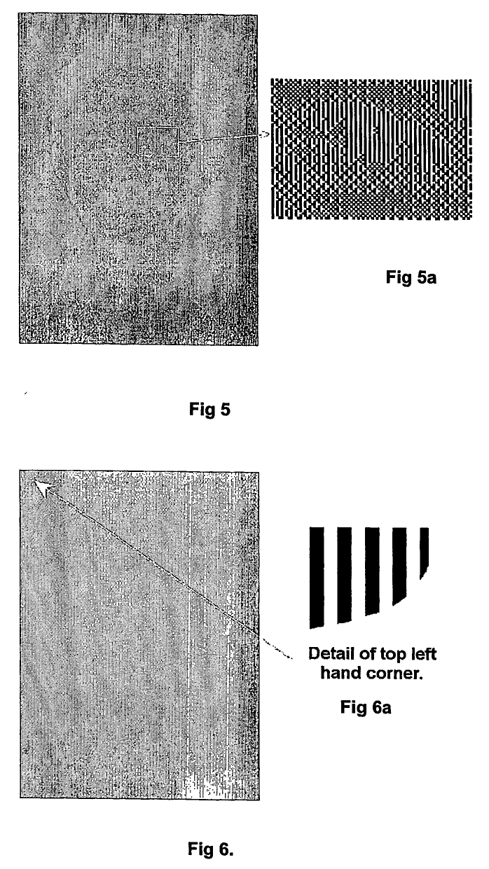

FIG. 5 depicts the resulting primary pattern, comprising both the transformed “on” and “off” pixels of each pixel pair with the left eye area shown enlarged in FIG. 5a.

FIG. 6 depicts the secondary pattern which corresponds to the primary pattern shown in FIG. 5. The secondary pattern is enlarged in FIG. 6a.

FIG. 7 depicts the image perceived by an observer when the primary pattern is overlaid with the secondary pattern. FIG. 7a shows an enlarged area of the eye 71 partially overlayed by the mask 72.

### EXAMPLE 2

This example depicts the effect of a variation in the second preferred embodiment, that is the effect of applying a scrambling algorithm to an original or a subject image prior to performing the transformation described in the second preferred embodiment.

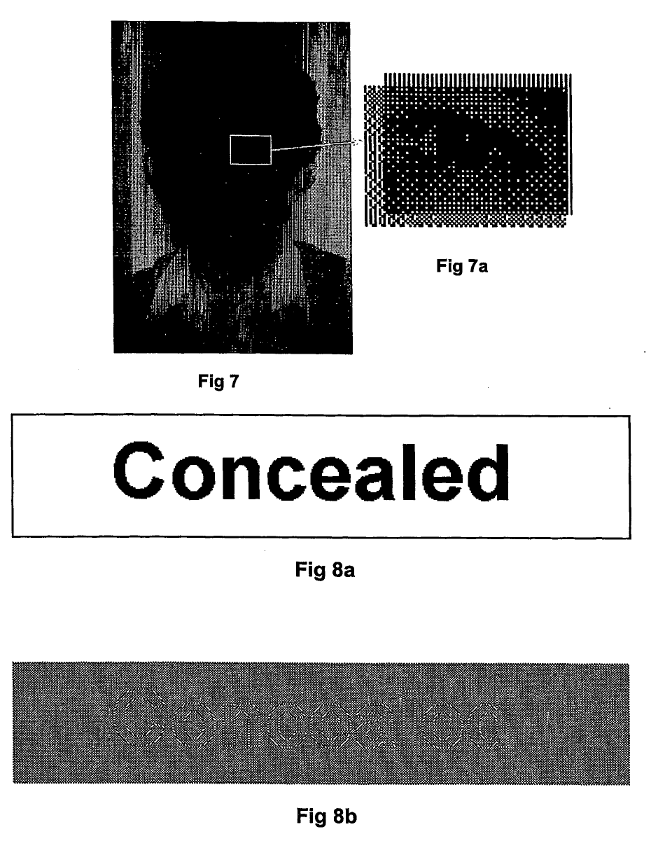

FIG. 8 an unscrambled subject image or an original image before FIG. 8a and after FIG. 8b transformation as described in the second embodiment using a chequered arrangement of pixel pairs.

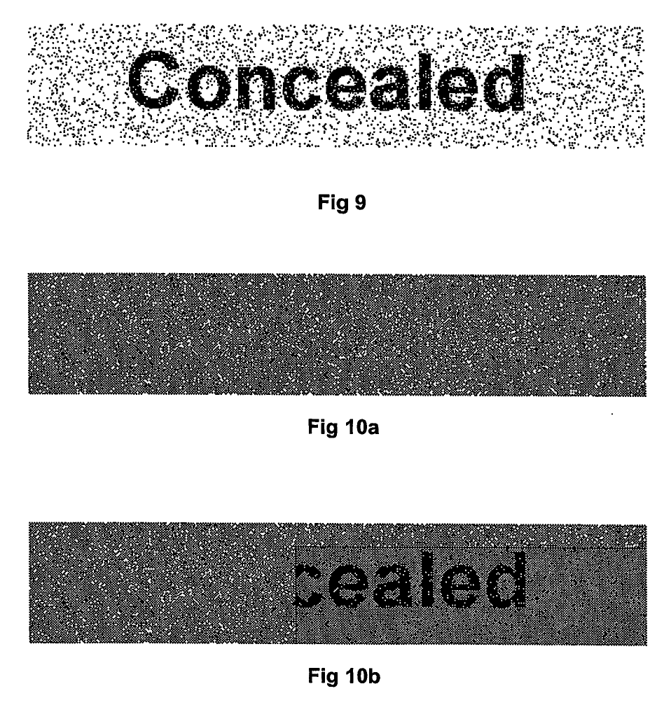

FIG. 9 depicts the original or subject image in FIG. 8a after a scrambling algorithm is applied.

FIG. 10a depicts FIG. 9 after the identical transformation employed in converting FIG. 8a to FIG. 8b is applied. It is clear that the latent image in FIG. 10a is far better concealed than in FIG. 8b.

Nevertheless, the latent image is present, as depicted in the bottom right corner of FIG. 10b, which shows FIG. 10a overlaid by the corresponding secondary screen.

### EXAMPLE 3

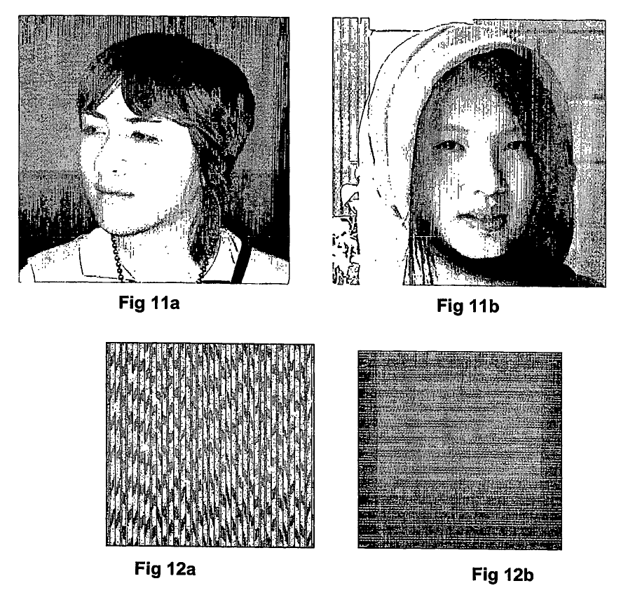

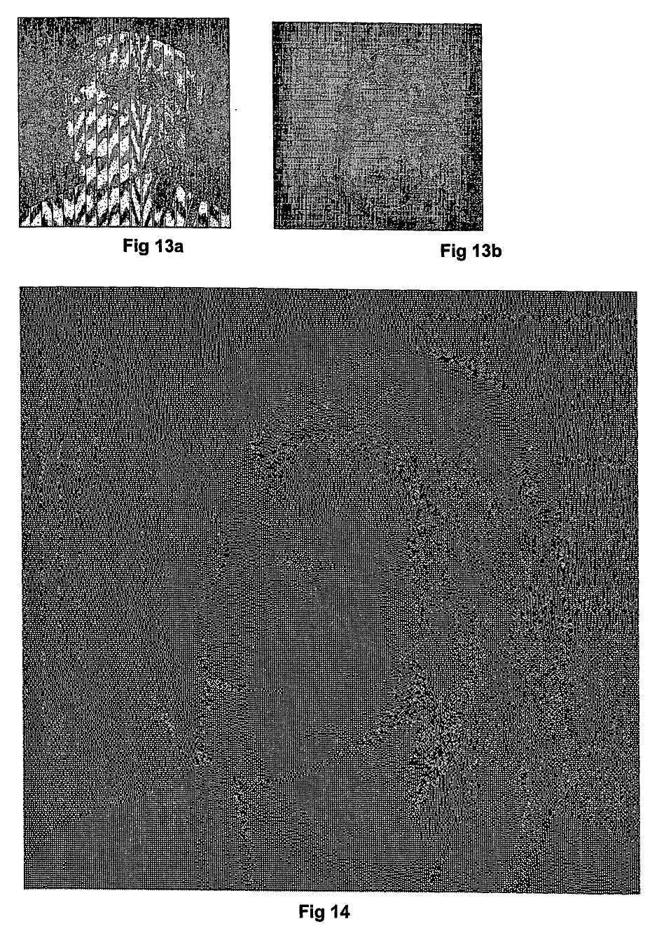

In the third example, two images are combined to form a latent image by using different secondary patterns (screens). Images of two different girls are shown in FIGS. 11a and 11b respectively. Two different secondary patterns are chosen that have the same resolution and are line screens where the first screen shown in FIG. 12a has vertical lines and the second screen shown in FIG. 12b has horizontal lines. Persons skilled in the art will appreciate that other combinations of angles, line resolutions and screen patterns could also be used. Latent images are produced for each pair of images and screens and are shown in FIGS. 13a and 13b, with FIG. 13a corresponding to the girl shown in FIG. 11a and the screen of FIG. 12a. and FIG. 13b corresponding to FIGS. 11b and 12b. The two latent images are combined by using a logical “or” process where black is taken as logic “one” and white is taken as logic “zero” as shown in FIG. 14. Persons skilled in the art will appreciate that other combination techniques and additional mathematical manipulations can be used equally well. For example, a logical “and” or “or” process may be followed by conversion of the resulting image into its negative, with this being used as the primary pattern.

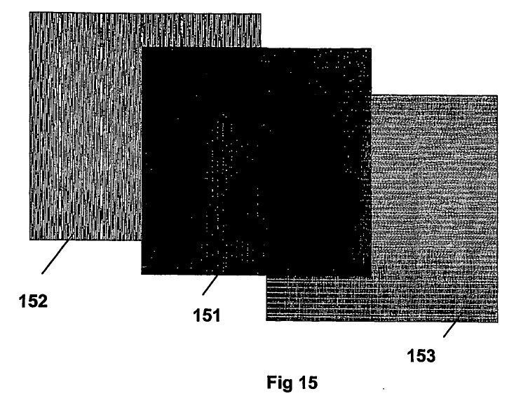

The decoding of the images is shown in FIG. 15 where it will be apparent that the two girls can be perceived where the respective screens 152 and 153 overlie the primary pattern 151.

It will be apparent to persons skilled in the art that further variations on the disclosed embodiments fall within the scope of the invention.

Persons skilled in the art will appreciate that depending on the method by which the drawings of this patent application are physically reproduced the concealed images in FIGS. 5 and 13 may be rendered somewhat visible by artefacts, such as banding or Moire effects. It is to be understood that such artefacts are a consequence of the limitations of the reproduction process employed and may therefore vary from one copy of this application to another. They do not form any part of the invention. Banding and other artefacts may also be seen in other figures, such as FIGS. 6, 12a-b, and in the screens 152 and 153 in FIG. 15.

1. A method of forming a latent image, the method comprising:
transforming a subject image into a latent image having a plurality of latent image element pairs, the latent image elements of each pair being spatially related to one another and corresponding to one or more image elements in said subject image, said transformation being performed by
allocating to a first latent image element of each pair, a value of a visual characteristic representative of the one or more corresponding image elements of the subject image, and
allocating to a second latent image element of the pair a value of a visual characteristic which is substantially complementary to the value of the visual characteristic allocated to said first latent image.

2. A method as claimed in claim 1, wherein each pair of latent image elements corresponds to a pair of subject image elements.

3. A method as claimed in claim 1, wherein each pair of latent image elements corresponds to one subject image element.

4. A method as claimed in claim 1, wherein each pair of latent image elements corresponds to a plurality of subject image elements.

5. A method as claimed in claim 2, wherein allocating a value of the visual characteristic comprises allocating a combination of the values of the visual characteristics of subject image elements.

6. A method as claimed in claim 5, wherein each pair of latent image elements corresponds to a pair of subject image elements and the combination is an average of the values of the pair of subject image elements.

7. A method as claimed in claim 4, wherein allocating a value of the visual characteristics comprises allocating a combination of the values of the visual characteristics of the plurality of subject image elements.

8. A method as claimed in claim 7, wherein allocating a combination of the values comprises allocating an average of the values.

9. A method as claimed in claim 3, wherein allocating a value comprises allocating the value of the visual characteristic of the corresponding subject image element.

10. A method as claimed in claim 2, wherein allocating a value comprises allocating a value of the visual characteristics determined from subject image elements nearby the corresponding subject image element.

11. A method as claimed in claim 10, wherein allocating a value comprises allocating the mode of the values of nearby subject image elements.

12. A method as claimed in claim 1, further comprising:
forming a subject image by dithering an original image into subject image elements which have one of a set of primary visual characteristics; and
selecting spatially related pairs of subject image elements in the subject image to be transformed.

13. A method as claimed in claim 1, wherein the image elements are pixels.

14. A method as claimed in claim 12, wherein the set of primary visual characteristics is a set of grey-scale values.

15. A method as claimed in claim 12, wherein the primary visual characteristics are red, green and blue, each in maximum saturation.

16. A method as claimed in claim 12, wherein the primary visual characteristics are cyan, yellow, magenta and black, each in maximum saturation.

17. A method as claimed in claim 1, wherein elements of image element pairs alternate down one column or one row.

18. An article having thereon a latent image that encodes a subject image, the latent image comprising:
a plurality of latent image element pairs, the image elements of each pair being spatially related to one another, each image element pair corresponding to one or more image elements of a subject image,
a first latent image element of each pair having a first value of a visual characteristic representative of a value of a visual characteristic of the one or more corresponding image elements of the subject image, and
a second latent image element of each pair having a second value of a visual characteristic substantially complementary to said first value.

19. An article as claimed in claim 18, wherein said first value is the value of the visual characteristic of one corresponding image element of the subject image.

20. An article as claimed in claim 18, wherein said first value is a value of the visual characteristic derived from a plurality of image elements of the subject image including at least said corresponding image element.

21. An article as claimed in claim 20, wherein said first value is a value of the visual characteristic derived from an average of the visual characteristics of a pair of corresponding image elements of the subject image including at least said corresponding image element.

22. An article as claimed in claim 18, wherein said first value is the value of the visual characteristic is derived from image elements of the subject image which are nearby to said one or more corresponding image elements.

23. An article as claimed in claim 19, wherein each first value takes one of a set of primary visual characteristics.

24. An article as claimed in claim 23, wherein the set of primary visual characteristics is a set of grey-scale values.

25. An article as claimed in claim 23, wherein the primary visual characteristics are red, green and blue, each in maximum saturation.

26. An article as claimed in claim 23, wherein the primary visual characteristics are cyan, yellow, magenta and black, each in maximum saturation.

27. An article as claimed in claim 19, wherein the image elements are pixels.

28. An article as claimed in claim 19, wherein elements of image element pairs alternate down one column or one row.

29. A method of verifying authenticity of an article, comprising providing a primary pattern on said article, said primary pattern containing a latent image comprising:
a plurality of latent image element pairs, the image elements of each pair being spatially related to one another, each image element pair corresponding to one or more image elements of a subject image,
a first latent image element of each pair having a first value of a visual characteristic representative of value of a visual characteristic of the one or more corresponding image elements of the subject image, and
a second latent image element of each pair having a second value of a visual characteristic substantially complementary to said first value; and
providing a secondary pattern which enables the subject image to be perceived.

30. A method as claimed in claim 27, wherein said first value is the value of the visual characteristic of one corresponding image element of the subject image.

31. A method as claimed in claim 29, wherein said first value is a value of the visual characteristic derived from a plurality of image elements of the subject image including at least said corresponding image element.

32. A method as claimed in claim 31, wherein said first value is a value of the visual characteristic derived from an average of the visual characteristics of a pair of corresponding image elements of the subject image including at least said corresponding image element.

33. A method as claimed in claim 29, wherein said first value is the value of the visual characteristic is derived from image elements of the subject image which are nearby to said one or more corresponding image elements.

34. A method as claimed in claim 19, wherein each first value takes one of a set of primary visual characteristics.

35. A method as claimed in claim 34, wherein the set of primary visual characteristics is a set of grey-scale values.

36. A method as claimed in claim 34, wherein the primary visual characteristics are red, green and blue, each in maximum saturation.

37. A method as claimed in claim 34, wherein the primary visual characteristics are cyan, yellow, magenta and black, each in maximum saturation.

38. A method as claimed in claim 29, wherein the image elements are pixels.

39. A method as claimed in claim 29, wherein said secondary pattern comprises a mask comprising a plurality of transparent and opaque portions having the same spatial relationship as. the first and second latent image elements.

40. A method as claimed in claim 39, wherein elements of image element pairs alternate down one column or one row.

41. A method as claimed in claim 29, wherein said secondary pattern comprises a lenticular lens screen which enables said subject image to be perceived from at least a first angle.
